(19) United States
(12) Patent Application Publication
(10) Pub. No.: US 2025/0384573 A1
(43) Pub. Date: Dec. 18, 2025

(54) METHOD AND DEVICE FOR GENERATING A DEPTH MAP AND/OR OPTICAL FLOW

(71) Applicants: CARIAD SE, Wolfsburg (DE); Robert Bosch GmbH, Stuttgart (DE)

(72) Inventor: Maximilian Jansen, Wolfsburg (DE)

(21) Appl. No.: 19/236,835

(22) Filed: Jun. 12, 2025

(30) Foreign Application Priority Data
Jun. 14, 2024 (DE) 10 2024 116 863.3
Aug. 21, 2024 (DE) 10 2024 123 824.0

(51) Int. Cl. G06T 7/593; G06T 7/246

(52) U.S. Cl. CPC G06T 7/593; G06T 7/248; G06T 2207/20084; G06T 2207/20228; G06T 2207/30252

(57) ABSTRACT

The disclosure relates to a method for determining a depth map and/or an optical flow, comprising providing a first feature map of a first image and a second feature map of a second image, generating a plurality of transformed feature maps from the first feature map and a plurality of scale factor candidates, wherein each of the transformed feature maps is generated by shifting each pixel of the first feature map along an epipolar line by a respective one of the scale factor candidates, computing a cost volume based on the transformed feature maps and the second feature map, and determining a disparity map based on the cost volume, wherein the disparity map specifies the depth map or the optical flow.

### BACKGROUND

### Technical Field

The disclosure relates to a method and a device for determining a depth map and/or optical flow or, in particular, a disparity map, as well as a motor vehicle having such a device.

### Description of the Related Art

Determining a depth map or optical flow is important in the field of autonomous driving. However, known methods for this purpose are inaccurate.

### BRIEF SUMMARY

Embodiments of the present disclosure provide an improved method and an improved device for determining a depth map or optical flow.

According to a first aspect, a method for determining a depth map and/or for determining optical flow is specified.

In this case, the method according to the disclosure comprises the steps of providing a first feature map of a first image and a second feature map of a second image, generating a plurality of transformed feature maps from the first feature map and one each from a plurality of scale factor candidates, wherein generating a transformed feature map for each pixel of the first feature map comprises displacing the pixel along an epipolar line by the respective scale factor candidate, computing a cost volume based on the transformed feature maps and the second feature map, and determining a disparity map based on the cost volume, wherein the disparity map specifies a depth map or optical flow or can be generated therefrom, as will be explained below.

The method according to the disclosure makes it possible to determine a depth map and optical flow using the same method. Furthermore, the method according to the disclosure allows the depth map and the optical flow to be determined particularly precisely, especially in an area around the epipole.

The method achieves the highest accuracy at a certain distance from the epipole, as the distances to the epipole can be determined most reliably there. Closer to the epipole, the method exhibits aleatoric uncertainty, as the distances to the epipole are smaller relative to the pixel density. Nevertheless, the method's overall accuracy, and especially near the epipole, is significantly higher than that of other methods.

For this purpose, a first feature map of a first image and a second feature map of a second image are provided in a first step. If the method is intended to determine a depth map, the first feature map can represent an image from a first camera and the second feature map can represent an image from a second camera. In particular, the images from the two cameras overlap completely or partially.

A feature map is a matrix created by running a filter or kernel over an input image to detect specific features or patterns in the image. These features could be edges, corners, textures, or other image-specific details.

The feature map can be created, in particular, by filtering the image or convolving it with a kernel. The feature map can also be created, in particular, by processing an image in a convolutional neural network.

To this end, the filter is applied to different positions in the image, and for each position a value is computed that reflects the presence of the feature at that location.

A feature map contains the response of a specific filter to the input image. It shows where and how strongly certain features are present in the image. By stacking and processing these feature maps, convolutional neural networks can detect and analyze complex patterns and structures in images.

An entry in the feature map is based on information about a corresponding pixel in the image, as well as information about the surrounding pixels. This can make it easier to identify motion in a feature map compared to the input image(s).

If the method is intended to determine optical flow, the first feature map can represent an image of a first point in time and the second feature map can represent the image of a second point in time.

In this case, the camera location of the first image and the camera location of the second image may be different from each other and, in particular, characterized by a movement of the camera through three-dimensional space. The feature maps may be provided by a deep learning image encoder, which converts images into a compact, informative representation within a neural network.

In a further step, a plurality of transformed feature maps are generated from the first feature map and one each from a plurality of scale factor candidates.

Generating a transformed feature map generally comprises a transformation that alters the image or feature map to fit a new geometry. This transformation may include scaling, rotation, translation, or nonlinear distortion.

In particular, the first feature map is rectified in a first transformation, i.e., a rotational component is removed by way of a homography. In other words, the image is rotated or adjusted so that it has a standardized orientation. A homography describes the relationship between two perspectives within a three-dimensional scene and is represented by a 3×3 matrix. In particular, the homography used describes the relationship between the perspective of the input image and a standardized perspective located in the epipolar plane.

Generating a transformed feature map in the method comprises displacing each pixel of the first feature map along an epipolar line by the respective scale factor candidate. In particular, this transformation occurs after rectification.

In this case, the epipolar line describes the curve on which, in the projection plane of a second camera, all points lie that are projected onto the same point in the projection plane of a first camera. For a pinhole camera, which can be used as a general approximation for most cameras, the epipolar line is a straight line. For other cameras, such as cameras with radial distortion, the epipolar line can be a curved line.

Every point in the image from the first camera has a corresponding epipolar line in the image from the second camera. All epipolar lines in the image from the second camera meet at one point, the so-called epipole.

In other words, the pixel is displaced along a curve that connects the pixel and the epipole, with the distance between the pixel and the epipole being scaled by the scale factor candidate. The curve can be a straight line or a curved line, as described.

In this case, the epipole is the point at which a line passing through the respective camera locations of the first image and the second image intersects the image plane of a camera.

By way of example, the displacement in this case can be described for a pinhole camera by the equation

$$\vert x - e \vert \to {s}_{i} \vert x - e \vert$$

wherein, is x is the pixel, e is the epipole, and, sᵢ is the scale factor candidate. In other words, the displaced pixel x′ is defined by x′=e+sᵢ(x−e).

By scaling the vector between a pixel and the epipole, the displacement of those pixels that are further away from the epipole is greater and thus coarser, while the displacement of those pixels that are closer to the epipole is smaller and can therefore be graded more finely.

This is advantageous because, typically, the optical flux near the epipole is in fact lower than at some distance from the epipole. In particular, the epipole is located in or near the center of the image for a forward-moving camera. For a laterally rotated or displaced camera, the epipole can also be located in peripheral areas or even outside the image. However, since the first image and/or the second image are/is captured by a forward-moving camera or image capture device, the epipole is located in particular in the center of the image, and these terms can then also be used synonymously.

Furthermore, unlike other methods, a depth map obtained from optical flow triangulation is finite at the epipole. This makes the method particularly robust and easy to handle.

In addition, the scaling of the method reduces costs. This allows the method to achieve particularly high levels of precision overall.

In a further step, a cost volume is computed based on the transformed feature maps and the second feature map.

In common methods, the cost volume is a mapping that specifies, for each pixel, the cost of a particular displacement between the two images.

For this purpose, the cost function is computed for each pixel position and each scale factor candidate, and the result is entered into the cost volume. This means that each pixel in the first image is checked for how well it matches various candidate pixels in the second image.

In the method according to the disclosure, the cost volume comprises, in particular, only those pixels that lie on an epipolar line. Pixels outside an epipolar line can and/or need not be considered. Instead, the new pixel positions on the epipolar line are computed for each scale factor, and the result is entered into the cost volume.

In doing so, and due to the scalability, the method significantly reduces the cost volume compared to conventional methods. This allows the method to achieve particularly high levels of precision overall.

The costs are defined by a cost function that measures the similarity between pixels in the two images. For example, the cost function can be defined by a correlation or a dot product of a feature vector from one of the transformed feature maps and a feature vector from the second feature map.

The cost volume can then be aggregated using a neural network to determine the best scale factor candidate for each pixel. In this case, the best scale factor candidate is the one for which the corresponding pixel from the first feature map, when scaled along the epipolar line, falls on the corresponding pixel from the second feature map that belongs to the same point in the underlying three-dimensional scene.

In a further step, a disparity map is determined based on the cost volume, wherein the disparity map specifies a disparity or optical flow.

The disparity map is a two-dimensional matrix, each entry of which specifies the offset of two corresponding pixels belonging to the respective point. In stereography, the offset of two corresponding pixels is referred to as disparity. For sequential images, the offset of two corresponding pixels taken from two temporally consecutive images is referred to as optical flow. A depth map can be computed from the disparity map, as explained in more detail below.

In particular, the disparity map in the present method specifies for each pixel the displacement that leads to a high similarity between the transformed feature map and the second feature map.

The disparity map can be determined, for example, by max-or softmax-aggregation along the dimension of the scale factor candidates. For this purpose, first, the cost volume is aggregated along the scale factor candidates to determine a best scale factor candidate, i.e., the scale factor for a pixel. The disparity or optical flow is obtained by multiplying the scale factor s reduced by 100% by the distance or vector from the pixel to the epipole PE, i.e., (s−1)×PE.

If the first feature map represents an image from a first camera and the second feature map represents an image from a second camera, the disparity map specifies a stereographic disparity. From this stereographic disparity, a depth map can be computed. For this purpose, a focal length f and a camera distance b must be known, for example, through extrinsic and/or intrinsic calibration. The disparity d and the depth T can then be interconverted using the equation d=b×f÷T.

If the first feature map represents an image from a first point in time and the second feature map represents the image from a second point in time, the disparity map specifies optical flow. From this optical flow, a depth map can then be determined by way of triangulation, taking into account an odometry or the vehicle's odometry.

The depth map determined by the method describes the pattern of the distances of image objects from the camera location orthogonal to the image plane. Depth specifies the distance of an object orthogonal to the image plane.

The optical flow determined by the method describes the pattern of apparent movement of image objects between two consecutive frames of a sequence, which is caused by the movement of the object or the camera.

The depth map and the optical flow can be used, in particular, by a motor vehicle to understand and navigate the surroundings, detect obstacles and react accordingly.

The depth map and the analysis of the optical flow can be used to reconstruct the three-dimensional structure of a scene underlying the images.

The efficient and precisely determined depth map and the optical flow are used to determine possible paths for the further travel of a motor vehicle, to estimate the relative speed of objects in a scene, to determine the time until a possible collision of the motor vehicle with such objects, and to steer the motor vehicle through the scene.

The availability of efficient and precise depth maps and optical flow are a prerequisite for an autonomous control of the motor vehicle to have an understanding of its surroundings.

A detailed resolution of the depth map and the optical flow in the surroundings or vicinity of the epipole, in which the direction of travel of the vehicle is located, is important.

The method according to the disclosure makes it possible to determine a depth map and optical flow by way of the same method. Furthermore, the method according to the disclosure allows the depth map and the optical flow to be determined particularly precisely. In particular, the depth map and the optical flow can be determined precisely in an area around the epipole, where precision is particularly important.

As described, the method computes a disparity map, which may specify a depth map and/or optical flow. Alternatively, the method can be used to compute the disparity map per se, without it specifying a depth map or optical flow.

According to a refinement, the method is carried out by way of a convolutional neural network trained by unsupervised machine learning.

Employing unsupervised learning requires a method with a low error rate. The method reliably prevents divergences in an area around the epipole. As a result, the depth can be reliably computed and thus a depth map can be created.

In this way, the method can be carried out by way of a convolutional neural network trained by unsupervised machine learning.

This refinement makes it possible for the method to be more accurate and reliable, eliminating the need for error-prone synthetic training data.

According to a refinement, the plurality of scale factor candidates are determined based on a maximum expected optical flow.

The scale factor candidates in this case are not larger than

$${s}_{max} = 1 + {u}^{max} / {r}_{x}^{max} ,$$

wherein

$${r}_{x}^{max}$$

is the maximum distance of a pixel from the epipole and wherein u^{max} is the maximum expected displacement of a pixel.

This refinement makes it possible to keep the number of scale factor candidates low while simultaneously achieving high displacement resolution. As a result, high accuracy can be achieved with low computational effort.

According to a further development, the epipole for determining a depth map is set to the left or right outside the image.

In doing so, the epipole is set to the left or right of the image, specifically at a distance of at least a multiple of the horizontal resolution of the image. The depth map is, in particular, a stereographic depth map.

This refinement makes it possible to use the method without further modifications to determine a depth map. This makes the method particularly flexible and efficient. Furthermore, as a result, stereographic and optical flow datasets can be combined. This allows for an expanded data base for training neural networks.

The epipole can also be determined using known correspondence methods, especially when no odometry information is available.

This makes it possible to use the method without further modifications to determine optical flow, especially when no odometry information is available. This makes the method particularly flexible and efficient.

According to a refinement, the first feature map represents an image of a camera at a first point in time, and the second feature map represents the image of the same camera at a second point in time, and the method determines a depth map.

As described above, optical flow can be determined from two sequential images from the same camera. For objects that are stationary relative to the camera, i.e., that move collinearly with the camera, the optical flow determined by the method is nonzero.

Instead, a so-called fake flow is determined, which can be specified by

$${u}^{fake} = \frac{- {t}_{z} ( x - e )}{{Z}_{x} + {t}_{z}} ,$$

wherein Z, is the depth of the pixel's back-projection into three-dimensional space and t or t_{z} is the displacement between the respective centers of the camera position at the two points in time.

By reverse triangulation a depth map can be determined, namely according to

$$\frac{1}{{Z}_{x}} = - \frac{1}{{t}_{z}} \frac{{u}^{fake}}{{u}^{fake} + x - e} = - \frac{1}{{t}_{z}} \frac{s - 1}{s}$$

wherein s is the scale factor candidate determined based on the cost volume.

This refinement makes it possible to quickly and reliably determine a depth map, making the method particularly flexible and efficient.

For use cases or application scenarios that may arise in connection with the method and are not explicitly described here, it may be provided that, in accordance with the method, an error message and/or a request to enter user feedback is output and/or a default setting and/or a predetermined initial state is set.

According to a further aspect, a device is specified. The device may have a data processing device and/or a processor unit configured to carry out an embodiment of the method according to the disclosure.

In particular, the device is designed to perform or at least effect the steps of the method described above. The device may also comprise one or more cameras, have access to them, and/or interact with them.

For this purpose, the processor unit can have at least one microprocessor and/or at least one microcontroller and/or at least one FPGA (Field Programmable Gate Array) and/or at least one DSP (Digital Signal Processor). In particular, a CPU (Central Processing Unit), a GPU (Graphical Processing Unit) or an NPU (Neural Processing Unit) can be used as the microprocessor. Furthermore, the processor unit can have program code which, when executed by the processor unit, is configured to perform the embodiment of the method according to the disclosure. The program code can be stored in a data memory of the processor unit. The processor unit can, for example, be based on at least one circuit board and/or on at least one SoC (System on Chip).

According to a further aspect, a motor vehicle is specified which comprises such a device.

The motor vehicle according to the disclosure is preferably configured as an automobile, in particular as a passenger car or a truck, or as a passenger bus or a motorcycle. In particular, the motor vehicle is designed as an autonomous motor vehicle that can perform one or more driving functions autonomously, without the intervention of a driver or passenger.

As a further solution, the disclosure also comprises a computer-readable storage medium comprising program code which, when executed by a computer or computer network, causes the computer or computer network to carry out an embodiment of the method according to the disclosure. The storage medium can be provided at least partially as a non-volatile data memory (e.g., as a flash memory and/or as an SSD—solid state drive) and/or at least partially as a volatile data memory (e.g., as a RAM—random access memory). The storage medium can be arranged in the computer or computer network. However, the storage medium can also be operated, for example, as a so-called app store server and/or cloud server on the Internet. The computer or computer network can provide a processor circuit having, for example, at least one microprocessor. The program code can be provided as binary code and/or as assembler code and/or as source code of a programming language (e.g., C) and/or as a program script (e.g., Python).

The disclosure also comprises combinations of the features of the described embodiments. The disclosure therefore also comprises implementations that each have a combination of the features of several of the described embodiments, unless the embodiments are described as mutually exclusive.

With regard to the embodiments of the device, the motor vehicle and the storage medium as well as the associated advantages, reference is made to the embodiments of the method described above and the associated advantages.

Exemplary embodiments of the disclosure are described below. In the drawings:

FIG. 1 shows a diagram of two superimposed images of an exemplary sequence of an exemplary embodiment of a method for determining a depth map or optical flow.

The exemplary embodiments explained below are advantageous embodiments of the disclosure. In the exemplary embodiments, the described components of the embodiments each represent individual features of the disclosure that are to be considered independently of one another, each of which also refines the disclosure independently of one another. Therefore, the disclosure is intended to comprise combinations of the features of the embodiments other than those shown. Furthermore, the described embodiments can also be supplemented by further features of the disclosure already described.

### BRIEF DESCRIPTION OF THE SEVERAL VIEWS OF THE DRAWINGS

In the figures, same reference numerals denote elements with the same function.

FIG. 1 shows a diagram of two superimposed images of an exemplary sequence of an exemplary embodiment of a method for determining a depth map or optical flow.

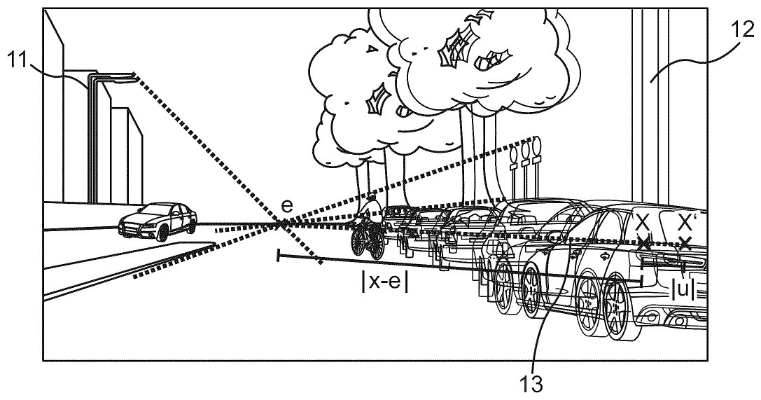

The method provides a first feature map of a first image 11 and a second feature map of a second image 12. FIG. 1 shows the first image 11 and the second image 12 superimposed on each other.

### DETAILED DESCRIPTION

In first image 11, an exemplary pixel x and epipole e are marked. The point in the three-dimensional scene underlying the images that is projected onto pixel x in first image 11 is projected onto the pixel x′ marked in second image 12.

The vector from point x to epipole e is denoted by |x−e|. The vector from point x′ to point x lies on the same straight line, namely the epipole line of x, and is denoted by |u|

In FIG. 1, second image 12 is taken at a later point in time using the same camera as first image 11.

In other embodiments not shown, second image 12 may be taken at the same time as first image 11 with a different camera.

Transformed feature maps are generated from the first feature map associated with first image 11. For this purpose, the first feature map is scaled with a scale factor candidate by displacing each pixel x along an epipolar line 13 by the respective scale factor candidate. Epipolar line 13 is the straight line through epipole e and pixel x.

Based on the transformed feature maps and the second feature map, a cost volume is computed that specifies for each pixel how high the similarity of the pixels in the transformed feature map is with the corresponding pixels in the second feature map for the respective scale factor candidates.

Based on the cost volume, a disparity map is determined, which specifies a depth map or optical flow.

In particular, the method can be carried out by way of a convolutional neural network trained by unsupervised machine learning.

In particular, the plurality of scale factor candidates can be determined based on a maximum expected optical flow.

Overall, the examples show how the method for generating a depth map or optical flow can be provided.

The following describes embodiments and features that can be employed both additionally and alternatively.

A method for combining dense correspondence algorithms for two or more 2D images using epipolar geometry and deep learning.

First embodiment: A method for computing optical flow from image sequences.

Second embodiment: A method for computing the disparity of stereo images.

Third embodiment: A method for computing disparity for overlapping cameras.

Fourth embodiment: A method for computing the depth of image sequences

For automated driving, an understanding of the three-dimensional structure and dynamics of the vehicle's environment is of utmost importance. Therefore, upstream tasks such as stereo matching, optical flow, or multi-view stereo computations are advantageous for deriving precise 3D and scene flow information. Although stereo matching, overlapping camera image matching, optical flow, and multi-view stereo reconstruction address very similar tasks, the algorithms used to compute these quantities, particularly those based on deep learning (DL), still differ significantly to this day.

A method is described that unifies the aforementioned tasks, thereby simplifying software architectures and DL training methods and improving performance across all tasks.

Efficient determination of the optical flow from a reduced-dimensionality cost volume by resolving the epipolar constraint.

FIG. 1 shows the superposition of two rectified RGB images, I₀ and I₁, taken at points in time t₀ and t₁ in the auto-epipolar case, i.e., e₀=e₁=e₁. Two randomly selected matching pixels are denoted by x and x′, and the optical flow from pixel x to x′ is denoted by u; e, x, x′, u∈ [symbol] ². For each image, feature maps F₀ and F₁ are extracted, e.g., using a deep learning-based image encoder. A set of warped feature maps {F^{warped}₀ᵢ} is obtained by scaling the distance of each pixel to the epipole rₓ=|x−e|, with scale factor candidates si∈(0, ∞), i∈N, according to

$$x \to e + si ( x {-}^{.} e )$$

$$or$$

$$x \to e + si ( x - e ) .$$

As a result, the pixels are displaced along their epipolar lines.

Next, a cost volume is constructed and aggregated, e.g., by concatenating warped feature maps {F^{warped}₀ᵢ} with the unwarped feature map F and using a deep learning-based decoder Φ:

$${C}^{agg} = Φ ( \{ {{F}^{warped}}_{0 i} {F}_{1} \} ) .$$

Alternatively, the dot product of the feature vectors of the warped feature maps {F^{warped}₀ᵢ} with the feature vectors of the feature map F₁ can be computed and concatenated as follows

$${C}^{agg} = \{ {{F}^{warped}}_{0 i} \cdot {F}_{1} \} .$$

Finally, the scale factor for each pixel can be obtained by utilizing, for example, maximum or softmax aggregation along the dimension of the scale factor candidate.

The output of the network is a scaling factor for each pixel (the scaling factor by which the distance of a pixel to the epipole, rₓ, must be multiplied to obtain the distance of the matching pixel x′ to the epipole, r_{x′}=|x′−e|).

The scaling factor that shifts the image point x to x′ (see FIG. 1) satisfies the equation

$$s {=}^{def} \frac{{r}_{{x}^{′}}}{{r}_{x}} = \frac{\vert {x}^{′} - e \vert}{\vert x - e \vert} = \frac{\vert x - e \vert + \vert u \vert}{\vert x - e \vert} = 1 + \frac{\vert u \vert}{\vert x - e \vert}$$

and therefore the optical flux for a pixel satisfying the epipolar condition can be computed as follows

$$u = ( s - 1 ) ( x - e ) .$$

The entire network can be trained continuously in a self-supervised or supervised manner.

The candidates for the scale factor can be selected according to a maximum considered optical flow u^{max}, using:

$$\begin{matrix}{s}_{min} = 1 - {u}^{max} / {r}_{x}^{max} \\ {s}_{max} = 1 + {u}^{max} / {r}_{x}^{max}\end{matrix} .$$

wherein rₓ^{max} is the maximum distance of the pixels to the epipole.

It should be noted that this scale factor approach is particularly precise near the epipole, as pixels near the epipole are displaced with a smaller absolute magnitude than pixels far from the epipole to construct the cost volume. This behavior is desirable, as absolute optical flux is expected to increase the farther the pixel is from the epipole.

### First Embodiment

A neural network that uses the previously computed optical flow (satisfying the epipolar condition) and optionally one or more feature maps as input to determine the optical flow in the general case.

The matching pixels determined above must satisfy the epipolarity condition, i.e., they must lie on an epipolarity line. While this is the case for the vast majority of pixels, especially for the use case driving, it may happen that some pixels do not lie on an epipolar line, e.g., for the general case of object movement. To determine a correct optical flow for these pixels as well, a subsequent neural network, e.g., a convolutional neural network (CNN) can be used, which uses the optical flow determined above and optionally the feature maps F₀ and F₁ as input and trains continuously in a self-supervised or supervised manner.

### Second Embodiment

A stereo matcher that uses exactly the same architecture as in the previously mentioned embodiment.

The network described in the previously described embodiment can be used without further modification to match stereo image pairs. For this purpose, an epipole is used that is located extremely far to the right (left disparity map) or extremely far to the left (right disparity map) and the same algorithm is used, as described above. Extremely far means that the pixel distance to the image edge is significantly larger than the horizontal resolution of the image. For identical datasets, the accuracy and computational effort are the same as with a cost-volume-based single-task stereo matcher. This combines stereo matching and optical flow computation.

The performance of both stereo matching and optical flow can be improved by training the network on a large combined optical flow and stereo dataset.

### Third Embodiment

A network that determines the disparity for overlapping cameras using exactly the same architecture as in the previously mentioned embodiment.

The network described in the previously described embodiments can be used without further modification to match image pairs from overlapping cameras. For this purpose, the epipole is determined from the extrinsic calibration of the two overlapping cameras and apply the same algorithm as above.

If the epipole is infinitely far away, essentially an epipole is used that is extremely far away in the same direction. Extremely far here means that the distance to the image edge is significantly greater than the diagonal resolution of the image. This standardizes disparity computation for overlapping cameras, stereo matching, and optical flow computation.

### Fourth Embodiment

A network that determines the depth of image sequences using exactly the same architecture as in the previously described embodiments.

The network, as described in the previous embodiments, can be used with further fine-tuning of the weights to determine depth quickly and accurately. For this purpose, a quantity called fake flow is introduced. The pseudo or fake flow is extracted from depth maps using inverse triangulation.

The fake flux for a pixel x in I₀, satisfies the equation:

$${u}^{fake} = \frac{{t}_{z} ( x - e )}{{Z}_{x} + {t}_{z}}$$

wherein Zₓ is the depth of the pixel's 3D reprojection, and is the relative pose between the two camera centers. It should be noted, that in a static environment, the pseudo flow matches the general optical flow. However, for moving objects, the apparent flow is different. Although both the truck and the black car are not moving with respect to the ego vehicle, their apparent flow is nonzero.

A fake flow has the advantageous property that, when triangulated using only ego-motion, it, by definition, also provides correct depth for (collinear) moving objects. The flow network from the previously described embodiments is ideally suited for training to predict false flows for three reasons:
1. Since it uses a deep learning-based architecture, it can learn to detect signatures of moving objects in the cost volume to predict their fake flow that is different from the optical flow.
2. It is particularly precise near the epipole (see above), a region where conventional multi-view stereo approaches exhibit large errors.
3. The triangulation of the false flow, which was determined from the method using the optical flow network, results in a finite (inverse) depth at the epipole:

$$\frac{1}{{Z}_{x}} = - \frac{1}{{t}_{z}} \frac{{u}^{fake}}{{u}^{fake} + x - e} = - \frac{1}{{t}_{z}} \frac{s - 1}{s}$$

wherein the scale factor s is the (finite) power of the network.

German patent application no. 10 2024 116 863.3, filed Jun. 14, 2024, and German patent application no. 10 2024 123 824.0, filed Aug. 21, 2024, to which this application claims priority, are hereby incorporated herein by reference in their entireties.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for determining a depth map and/or an optical flow, comprising:
providing a first feature map of a first image and a second feature map of a second image;
generating a plurality of transformed feature maps from the first feature map and a plurality of scale factor candidates, wherein each of the transformed feature maps is generated by shifting each pixel of the first feature map along an epipolar line by a respective one of the plurality of scale factor candidates;
computing a cost volume based on the transformed feature maps and the second feature map; and
determining a disparity map based on the cost volume, wherein the disparity map specifies the depth map or the optical flow.

2. The method according to claim 1, wherein the method is performed using a convolutional neural network trained by unsupervised machine learning.

3. The method according to claim 1, wherein the scale factor candidates are determined based on a maximum expected optical flow.

4. The method according to claim 1, wherein an epipole used to determine the depth map is set to be outside of the first image or the second image, on a left or right side of the first image or the second image.

5. The method according to claim 1, wherein an epipole used to determine the optical flow is defined centrally in the first image or the second image.

6. The method according to claim 1, wherein the first feature map represents an image of a camera at a first point in time, and the second feature map represents an image of the camera at a second point in time, and
wherein the method includes determining the depth map.

7. A device for controlling a motor vehicle, comprising:
a processor; and
a memory storing program code that, when executed by the processor, causes the device to:
generate a plurality of transformed feature maps from the first feature map and a plurality of scale factor candidates, wherein each of the transformed feature maps is generated by shifting each pixel of the first feature map along an epipolar line by a respective one of the plurality of scale factor candidates;
compute a cost volume based on the transformed feature maps and a second feature map; and
determine a disparity map based on the cost volume, wherein the disparity map specifies a depth map or an optical flow.

8. A motor vehicle comprising a device according to claim 7.
